(19) United States
(12) Patent Application Publication
(10) Pub. No.: US 2019/0256057 A1
(43) Pub. Date: Aug. 22, 2019

(54) AUTOMATED CAR WASH SYSTEM UTILIZING STEAM

(71) Applicant: Plover Inc., Milwaukie, OR (US)

(72) Inventors: Andrew Kim, Portland, OR (US); Victor Wang, Portland, OR (US); Jon Allen, Milwaukie, OR (US)

(21) Appl. No.: 16/397,924

(22) Filed: Apr. 29, 2019

Related U.S. Application Data
(63) Continuation of application No. 16/278,704, filed on Feb. 18, 2019.
(60) Provisional application No. 62/632,864, filed on Feb. 20, 2018.

(51) Int. Cl. B60S 3/04; G06T 17/00; G05B 19/042

(52) U.S. Cl. CPC B60S 3/04; G06T 17/00; G05B 2219/24024; G06T 2200/08; G05B 19/0428

(57) ABSTRACT

An automated/robotic car wash system is disclosed that is able to autonomously wash and dry a vehicle using steam and/or high-pressure water. High-pressure water, steam, and/or pressurized air outputs are mounted to a tool head, which is in turn mounted to the end of a multi-axis robotic gantry system wash that maneuvers around the surface of the vehicle. Also provided are vehicle washing processes that automatically controls the movement and operation of the system, through an automatic main controller that generates and analyzes input data in the form of a movement program, a safety program, a user entry program, a toolpath program, and/or a utilities management program.

### CROSS REFERENCE TO RELATED APPLICATIONS

This application is a continuation of U.S. Nonprovisional Utility patent application Ser. No. 16/278,704, filed Feb. 18, 2019, entitled “AUTOMATED CAR WASH SYSTEM UTILITZING STEAM,” which claims priority to U.S. Provisional Utility Patent Application Ser. No. 62/632,864, filed Feb. 20, 2018, entitled “AUTOMATED CAR WASH SYSTEM UTILITZING STEAM,” each application by inventors Kim, Wang, and Allen, the disclosures of which are incorporated by reference herein in their entirety.

### TECHNICAL FIELD

The present invention relates to an automated car wash system utilizing steam, the system automatically washing a vehicle using a multi-axis robotic gantry system. More specifically, the present invention relates to an automated car wash machine, an automated car wash apparatus, and an automated car washing method, which allow a user, who positions a vehicle to the automatic car wash system's operating area equipped with the automatic car washing apparatus, to go through car washing processes including a scanning process, a cleaning process, and a drying process, without getting out of the vehicle and without being required to open any door panels or open any windows

### BACKGROUND

The car wash industry has been present since 1914, not long after the invention of the car. Unfortunately, the progress that the car wash industry has experienced since then has relatively been non-existent compared to that of the automotive industry itself. While automotive manufacturers are pushed to produce as close to zero detriment to the environment and to provide more to the customer, car washes have largely remained the same, and continue to utilize highly concentrated chemicals and extreme-pH solutions to assist with their processes.

Recently, advances in car washing technologies have been proposed. For example, U.S. Pat. No. 7,806,128 to Kim Brillouet et al. describes an automatic steam car wash system that is comprised of a moving station and 10 metal beams that comprise a frame. Steam spraying nozzles, a vacuum nozzle, and a towel are installed in a moving station and moves along the surface of the car. Steam generators are installed inside of the moving station and connected to the steam spraying nozzles. A no water spill automatic car washing system is thereby purportedly realized.

Nevertheless, such proposed improvements raise new problems. For example, under-optimized layouts and inefficient design requires the business owner to have a considerably large plot of land. Similarly, certification/regulatory concerns are significant.

Thus, opportunities exist to provide additional improvements to known car wash systems using steam, as discussed below.

### SUMMARY

Embodiments provide an automated car wash system that utilizes steam to clean, sanitize, disinfect, wash, blast, blow, melt or otherwise assist in removing any artifacts that may exist on top of a vehicle's exterior surface. The steam can be provided from a boiler, transported through a network of pipes and valves, and outputted by one or more nozzles such that the steam is dispensed against exterior surfaces of the vehicle. Cleaning of the vehicle with steam can be automated such that that the nozzles and dispensing of steam can be controlled by a computer without human intervention. The utilization of steam allows the car wash system to achieve levels of sanitization and cleaning previously unachievable by traditional usage of water and chemicals. The utilization of steam requires less usage of water among other utilities due to the efficiency of steam cleaning. The utilization of steam also allows for shorter overall wash times due to a lesser number of wash stages as a result of the increased effectiveness of steam. Utilization of steam may also be used to maintain other parts of the system. For example, the heat from the steam portion of the system may be used to help prevent the freezing of pipes or other components during cold environments.

In some embodiments, an automated car wash system includes a supply module including a reservoir for storing water and a boiler for transforming at least a portion of the stored water into steam, a delivery module coupled to the control module, the delivery module including a motor and a pump for transporting the steam at a pressure level, and an outputting module coupled to the delivery module. The outputting module can include a valve assembly configured to receive steam from the delivery module, the valve assembly including a plurality of valves for controlling the flow of steam to different outputs; and one or more nozzle assemblies configured to dispense steam toward a vehicle, each nozzle assembly including a plurality of nozzles configured to output pressurized steam. The automated car wash system can further include a control module coupled to the delivery module and outputting module and configured to operate the automated car wash system, the control module including one or more processors coupled to memory containing code that when executed by the one or more processors causes the one or more processors to perform automated steam cleaning of a vehicle.

The boiler can be configured to generate steam that has a temperature of at least 212 degrees Fahrenheit. The valve assembly can be coupled between the pump and the one or more nozzle assemblies. The delivery module can include a variable frequency drive configured to output a signal at different frequencies to the motor to define the pressure level. The one or more nozzle assemblies can be movable by respective one or more motors (or tool heads) to position the one or more nozzle assemblies at a position suitable for steam cleaning. The automated car wash system can further include one or more sensors coupled between the pump and the valve assembly. The one or more sensors can be configured to monitor the output pressure and temperature of the pump.

In other embodiments, the invention provides an automated car wash system that includes a plurality of interoperative modules comprising a plurality of component parts, similar to the automated or automatic car wash system as described above.

For example, provided is an automated car wash system that utilizes pressurized water and steam to clean, sanitize, disinfect, wash, blast, blow, melt or otherwise assist in removing any artifacts that may exist on top of a vehicle's exterior surface. The pressurized water can be provided by a series of pump(s) and motor(s), which are fed by a water source and outputted by one or more nozzles such that the pressurized water is dispensed against exterior surfaces of a vehicle. Steam can be provided from a boiler or a steam generator, the boiler or steam generator being fed water by a series of pump(s) and motor(s) fed by a water source transported through a network of pipes and valves. The steam then being outputted by one or more nozzles such that the steam is dispensed against exterior surfaces of the vehicle. Cleaning of the vehicle with pressurized water and steam can be automated such that that the nozzles and dispensing of pressurized water and steam can be controlled by a computer without human intervention. The utilization of steam allows the car wash system to achieve levels of sanitization and cleaning previously unachievable by traditional usage of water and chemicals. The utilization of steam requires less usage of water among other utilities due to the efficiency of steam cleaning. The utilization of steam also allows for shorter overall wash times due to a lesser number of wash stages as a result of the increased effectiveness of steam. Utilization of steam may also be used to maintain other parts of the system. For example, the heat from the steam portion of the system may be used to help prevent the freezing of pipes or other components during cold environments.

In some embodiments, an automated car wash system includes a supply module including at least one reservoir for storing water and at least one boiler or steam generator for heating water, producing steam, or a combination of the two, a delivery module coupled to the control module, the delivery module including motor(s) and pump(s) for transporting water into the boiler(s) or steam generator(s) to produce steam at a temperature level, and for producing water at a pressure level and temperature level, and an outputting module coupled to the delivery module. The outputting module can include a valve assembly configured to receive water or steam from the delivery module, the valve assembly including a plurality of valves for controlling the flow of steam to different outputs; and one or more nozzle assemblies configured to dispense water or steam or a combination of water and steam toward a vehicle, each nozzle assembly including a plurality of nozzles configured to output water at a pressure level and temperature level or steam at a temperature level or a combination of water and steam at a pressure level and temperature level. The automated car wash system can further include a control module coupled to the delivery module and outputting module and configured to operate the automated car wash system, the control module including one or more processors coupled to memory containing code that when executed by the one or more processors causes the one or more processors to perform automated steam cleaning of a vehicle.

The boiler can be configured to generate steam that has a temperature of at least 212 degrees Fahrenheit. The valve assembly can be coupled between the pump and the one or more nozzle assemblies. The delivery module can include one or more variable frequency drive(s) configured to output a signal at different frequencies to the motor to define the pressure level or temperature level or flow rate or a combination of the three of any part of the system. The one or more nozzle assemblies can be movable by a multi-axis robotic gantry system controlled by the control module to maintain a precise and consistent distance and angle from any given surface of the vehicle. The automated car wash system can further include one or more sensors coupled to all moving and electronic parts of the system. The one or more sensors can be configured to monitor each part of the system to control temperature, pressure, flow rate, speed, position, angle, distance, color, material, size, shape, and any other property that allows for the safe and effective operation and cleaning of a vehicle.

In some embodiments, an automated car wash system that utilizes pressurized water and steam may also use air to dry a vehicle. The drying process involves an air blower or an air compressor which feeds air through a hose or a duct or multiple hoses or multiple ducts and outputs the air through one or more nozzles configured to create a blade of air known as an air-knife.

A better understanding of the nature and advantages of embodiments of the present invention may be gained with reference to the following detailed description and the accompanying drawings.

### BRIEF DESCRIPTION OF THE DRAWINGS

FIG. 1 is a simplified diagram of an exemplary automated car wash system, according to some embodiments of the present disclosure.

FIG. 2 is a block diagram of an exemplary automated car wash system, according to some embodiments of the present disclosure.

### DETAILED DESCRIPTION

### Overview and Definitions

Before describing the present invention in detail, it is to be understood that the invention is not limited to temperatures for steam, as such may vary. It is also to be understood that the terminology used herein is for the purpose of describing particular embodiments only, and is not intended to be limiting.

In addition, as used in this specification and the appended claims, the singular article forms “a,” “an,” and “the” include both singular and plural referents unless the context clearly dictates otherwise. Thus, for example, reference to “a module” includes a plurality of modules as well as a single module, reference to “a vehicle” includes a single vehicle as well as a collection of vehicles, and the like.

In this specification and in the claims that follow, reference will be made to a number of terms that shall be defined to have the following meanings, unless the context in which they are employed clearly indicates otherwise:

The term “algorithm” is used in its ordinary sense and refers to a process or set of rules to be followed in calculations or other problem-solving operations, typically by a computer.

The terms “automatic” and “automated” are typically used interchangeably herein to refer to of a device, system, or process working by itself with little or no direct human control. Similarly, an automated process is one that occurs spontaneously, without substantially conscious thought or simultaneous human intention.

The term “boiler” is used herein to encompass boilers, steam generators and other means for providing steam associated with the invention through application of heat to water.

The transitional phrase “consisting essentially of” limits the scope of a claim to the specified elements, materials or steps and those that do not materially affect the basic, novel, and nonobvious characteristic(s) of the claimed invention. A “consisting essentially of” claim occupies a middle ground between closed claims that are written in a ‘consisting of’ format and fully open claims that appear in a “comprising” format. Thus, “consisting essentially of” is not be interpreted synonymously with “comprising” of “consisting of”

The term “fluid” is used herein in its ordinary sense and refers to a substance that has no fixed shape and yields easily to external pressure such as a gas and/or or a liquid.

The term “gantry,” as in “gantry module” is typically be used herein to refer to a bridge-like overhead structure with a platform supporting equipment components of the invention such as cameras, sensors, nozzles, etc. However, the term may also be used in a robotics sense, e.g., as in a multi-axis gantry system.

“Optional” or “optionally” means that the subsequently described circumstance may or may not occur, so that the description includes instances where the circumstance occurs and instances where it does not.

The term “predetermined” is used herein in its ordinary sense and refers to established or decided in advance such that the invention operates at a preferred or optimal level.

The term “server” as in “network server” is used herein in its ordinary sense and refers a computer designed to act as central repository and help in providing various resources like hardware access, disk space, display and/or printer access, etc., to other computers in the network.

The term “water” is used in its ordinary sense and refers to a compound having the chemical formula H₂O. Typically, the term “water” refers to H₂O in a liquid state. Similarly, the term “steam” typically means water in at least a partially vaporous state, typically at a temperature of about 100° C. or above.

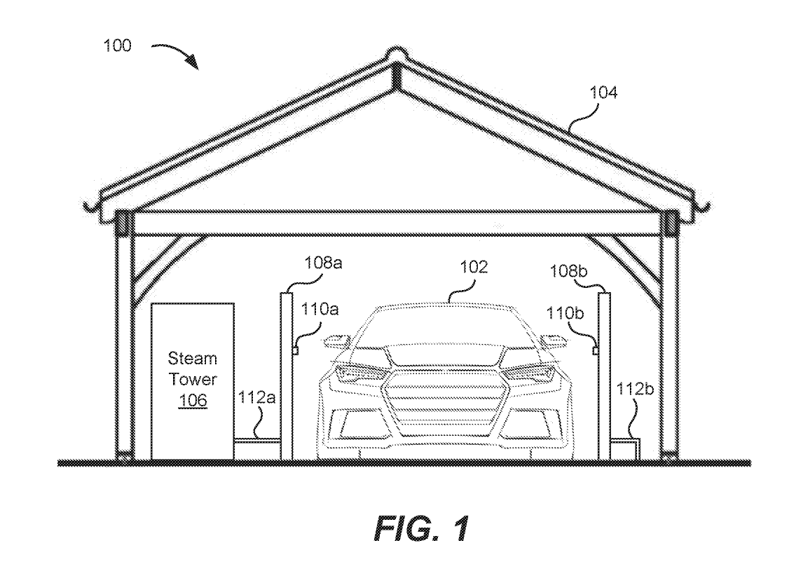

The invention pertains to an automated car wash system that utilizes pressurized water and steam to clean a car with little or no use of harsh chemicals and solutions. Pressurized water is water that is delivered and outputted at an elevated pressure level. Steam is water vapor existing at or above 100 degrees Celsius or 212 degrees Fahrenheit. When applied at various pressure levels and temperature levels during a car washing process, the dispensed water and steam vapor alone can separate a significant amount of dirt and grime from surfaces of the car. In some instances, the automated car wash system is a stand-alone system, such as a carport, that can provide an area where a car can park and be washed with steam in a covered or exposed environment. An example of such a system is shown in FIG. 1.

Example of Inventive Car Wash System

FIG. 1 is a simplified diagram of an exemplary automated car wash system 100 for a vehicle 102, according to some embodiments of the present disclosure. Although vehicle 102 is shown as a car; it is to be appreciated that automated washing systems disclosed herein can apply to any type of vehicle. For instance, automated washing systems herein can apply to manned vehicles, e.g., motorcycles, boats, buses, trains, planes, helicopters, and the like, and unmanned vehicles, e.g., drones, automated vehicles, containers, and the like. Showing and discussing the automated car wash system with respect to cars is not intended to be limiting.

In some embodiments, automated car wash system 100 includes a covering 104, such as a carport, or any other structure suitable for providing covering for a stationary vehicle. Covering 104 can be an open covering such that vehicle 102 is not totally enclosed during cleaning, or an enclosed covering where vehicle 102 is completely enclosed and sealed from the environment during cleaning. System 100 can include a carport door (not shown) that opens and closes to allow for entry and exit of vehicle 102. Covering 104 can shield vehicle 102 from the outdoor environment during cleaning so that particulates from the outside air do not hinder the cleaning process. Also, covering 104 can provide a controlled environment in which the automated cleaning using pressurized water and steam can be performed, thereby providing a suitable environment for efficient cleaning. In some embodiments, one or more drapes can be lowered to surround vehicle 102 within covering 104. That way, covering 104 may not need to include a carport door, but can still provide an enclosed region in which vehicle 102 may be cleaned with steam.

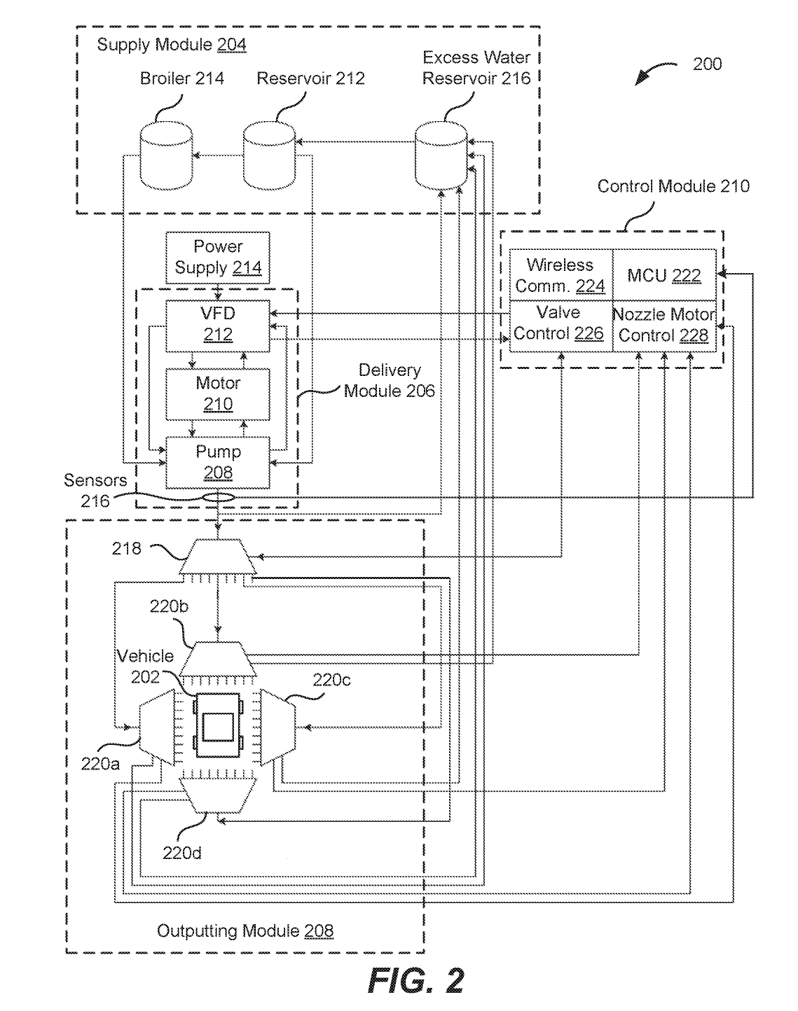

Automated car wash system 100 can also include an optional utility cabinet 106 for operating the cleaning apparatuses and devices during the automated vehicle cleaning process. For instance, utility cabinet 106 can include one or more control processors, communication systems, motors, pumps, and any other suitable component needed for the automated cleaning of a vehicle 102, as will be discussed further herein with respect to FIG. 2. Although utility cabinet 106 is shown as being covered by covering 104, embodiments are not so limited. Utility cabinet 106 can be positioned outside of covering 104 or implemented in the framework of covering 104. In some embodiments, utility cabinet 106 can be implemented in a separate framework (not shown) under covering 104 and around vehicle 102.

In some embodiments, automated car wash system 100 can also include a network of pipes, valves, and nozzles for transporting and outputting pressurized water or steam or air or a combination of the three to wash vehicle 102. As an example, utility cabinet 106 can be coupled to nozzle assemblies 108a and 108b via pipes 112a and 112b to output pressurized water or steam or air or a combination of the three. Nozzle assemblies 108a and 108b can include respective nozzles 110a and 110b that direct outputted pressurized water or steam or air or a combination of the three toward surfaces of vehicle 102. In some embodiments, nozzles 110a and 110b and/or nozzle assemblies 108a and 108b are movable so that nozzles 110a and 110b can move around vehicle 102 to strategically position themselves at key distances, e.g., about 1 cm to about 100 cm, preferably about 1 cm to about 30 cm, and key angles to effectuate efficient cleaning of vehicle 102 without damaging the vehicle or component and/or parts thereof. Furthermore, nozzles 110a and 110b can move so that they can reach all surfaces of vehicle 102. A more detailed explanation of the working parts in an exemplary automated car wash system is discussed further herein with respect to FIG. 2.

FIG. 2 is a block diagram of an exemplary automated car wash system 200 for washing a vehicle 202 with pressurized water or steam or air or a combination of the three, according to some embodiments of the present disclosure. System 200 shown in FIG. 2 can be the block diagram representation of system 100 shown as a simplified diagram in FIG. 1 so that the inner components and their interactions with one another are more easily conveyed and understood. In some embodiments, automated car wash system 200 includes a supply module 204, delivery module 206, outputting module 208, and a control module 210, each of which will be discussed in further detail herein.

Supply module 204 can be a part of system 200 that provides water vapor for steam cleaning and, in some cases, reclaims excess dispensed water vapor after condensing into liquid water to be later used for steam cleaning. For instance, supply module 204 can include a reservoir 212 for storing and supplying water. Reservoir 212 can be a tank of water or an outlet connected directly to the city's water supply. Supply module 204 can also include a boiler 214 for generating steam from water. Boiler 214 can be any suitable device that can heat water at or above boiling point to generate steam. In some instances, boiler 214 is coupled to reservoir 212 via a pipe to receive water for vaporizing into steam. In addition to reservoir 212 and boiler 214, supply module 204 can also include an excess water reservoir 216. Excess water reservoir 216 can be a device that collects excess water condensed from excess dispensed water vapor to supplement reservoir 212. In some embodiments, excess water reservoir 216 is coupled to reservoir 212 via a pipe.

Delivery module 206 can be a part of system 200 that provides transporting force to move the pressurized water or steam generated by boiler 214 or air or a combination of the three and to output the water or steam or air at various pressures or temperatures or both. For instance, delivery module 206 can provide mechanisms that move water or steam or air or a combination of the three through pipes to their end destinations (e.g., nozzles) with enough pressure or temperature or both to effectuate efficient and effective cleaning once outputted by those nozzles. The pressure or temperature or flow or a combination of the three can be modified and varied such that the outputted water or steam or air of a combination of the three can be outputted at various pressure levels or temperature levels or both. To enable this functionality, delivery module 206 can include a pump 208, motor 216, and a variable frequency drive (VFD) 212. Pump 208 can be any pump suitable for moving water or steam or air or a combination o the three with pressure. Motor 216 can be coupled to pump 208 via pipes and can be configured to control pump 208 to modify the pressure at which the steam moves through the pipes. VFD 212 can be a device that generates a signal at various frequencies. The frequency at which the signal propagates can operate motor 216 at a corresponding degree to dictate the outputted pressure or temperature or both accordingly. In some embodiments, delivery module 206 can include one or more sensors 216 that are positioned to monitor the output of pump 208. Sensors 216 can be any suitable sensor for monitoring the output pressure and temperature of water or steam or both from pump 208 to ensure that the outputted steam is suitable for efficient and safe cleaning. Delivery module 206 can be coupled to a power supply 214 that is suitable for supporting the operation of delivery module 206. For instance, power supply 214 can be a 3-phase 220V power supply that provides enough power to operate high-powered motors and pumps.

Outputting module 208 can be a part of system 200 that provides avenues through which water or steam or air or a combination of the three is transported and outputted to vehicle 208. For instance, outputting module 208 can include a valve assembly 218 and nozzle assemblies 220a-220d. Valve assembly 218 can be configured to receive water or steam or air or a combination of the three from pump 208 via pipes and output the water or steam or air or a combination of the three to different output destinations. For example, valve assembly 218 can be configured to have a single input valve and a plurality of output valves such that the valve assembly can open and close various output valves to dictate where the steam is outputted. Each output valve can be connected to a corresponding nozzle assembly 220a-220d, which can be positioned proximate to a surface of vehicle 202 that is to be cleaned. The valves in valve assembly 218 can be any suitable valve capable of opening and closing an aperture to allow a controlled passage of water or steam or air or a combination of the three. For instance, the valves can be a solenoid valve. Each nozzle assembly 220a-220d can include a plurality of nozzles arranged in a predefined configuration designed to effectuate an even and consistent dispensing of water or steam of air or a combination of the three across a broad surface. For instance, the nozzles can be arranged in a horizontal configuration, vertical configuration, or any other suitable configuration dictated by design. Nozzle assemblies 220a-220d can be moved to cover all surfaces of vehicle 202, as discussed herein with respect to FIG. 1. Thus, in some embodiments, each nozzle assembly 220a-220d can include a respective motor that moves the nozzle assembly to each designated part of vehicle 202.

In some embodiments, the outputted water or steam or air or a combination of the three alone can effectuate sufficient cleaning of the surfaces of vehicle 202. The high temperature along with the high pressure of the water or steam or air or a combination of the three exiting nozzle assemblies 220a-220d can remove the dirt and grime resting on the surfaces. However, in some embodiments, the outputted steam can be provided in conjunction with some chemicals and/or detergents to assist in cleaning the surfaces of vehicle 202. The amount of chemicals utilized may be less than the amount typically used with conventional car wash systems that utilize water in liquid form. Additionally, the type(s) of chemicals used with this automated car wash system may be less harsh than the strength of chemicals used with only liquid water. Additionally, the type(s) of chemicals used with this automated car wash system may be organic or naturally occurring in nature.

Control module 210 can be a part of system 200 that controls the operation of modules 204, 206, and 208 to perform automated cleaning of vehicle 202. In some embodiments, control module 210 and delivery module 206 can be housed in a single enclosure and positioned proximate to a covering. For instance, control module 210 and delivery module 206 can be positioned in utility cabinet 106 in FIG. 1 and positioned proximate to covering 104.

In some embodiments, control module 210 can include a main computing unit (MCU), wireless communication chipset 224, valve controller 226, and a motor controller 228. Wireless communication chipset 224 can be a chipset configured to enable wireless communication with one or more external devices, such as a smart phone, smart watch, laptop computer, tablet, and the like. Wireless communication chipset 224 enables automated car wash system 200 to send notices to a customer, such as a driver of vehicle 202, that indicate completion status of the automated vehicle wash, or to send and receive information, such as information about the process and advantages of steam cleaning or different types of cleaning, or customer reviews/feedback of the steam cleaning process by system 100. Valve controller 226 can be a controller that is configured to operate valve assembly 218 and VFD 212. Likewise, motor controller 228 can be a controller that is configured to operate the motors that move nozzles 220a-220d to the respective designated parts of vehicle 202.

MCU 222 can include one or more processors and memory configured to manage the operation of automated car wash system 200 to perform steam cleaning of vehicle 202. The memory can contain lines of code that instruct the processors to perform automated cleaning when executed. In some embodiments, MCU 222 is configured to control valve controller 226 and motor controller 228, as well as supply module 204, delivery module 206, and outputting module 208. MCU 222 can also be coupled to sensors 216 to monitor the output of pump 208 to ensure that the outputted steam is within specifications for steam cleaning. In some embodiments, MCU 222 can be programmed to automate the car washing process so that a person does not have to manually operate system 200. For instance, MCU 222 can be programmed so that system 200 can detect when a vehicle is approaching or has entered into the carport. The washing process can be triggered once the vehicle is detected to be in the carport, or when the driver of vehicle 202 initiates the washing process through a handheld device connected to control module 210 through wireless communication chipset 224. Once the washing process has been triggered, system 200 will automatically execute the washing process and the separate portions of the wash will be executed in sequence according to the programming of MCU 222. These separate portions include the application of pressurized water or steam or air or a combination of the three. That is, water from reservoir 212 is vaporized by boiler 214 into steam, which is then transported by motor 210 and pump 208 in delivery module 206 to specific nozzle assemblies 220a-220d dictated by valve assembly 218 in outputting module 208 through various pipes shown as solid lines in FIG. 2. Water may be used before or after the steam process, and drying may also be introduced at the end of the process.

Utilizing steam to clean vehicle 202 allows automated car wash system 200 to achieve levels of sanitization and cleaning previously unachievable by traditional usage of water and harsh chemicals. The utilization of steam requires less usage of water among other utilities due to the efficiency of steam cleaning. The utilization of steam also allows for shorter overall wash times due to a lesser number of wash stages as a result of the increased effectiveness of steam. Utilization of steam may also be used to maintain other parts of the system. For example, the heat from the steam portion of the system may be used to help prevent the freezing of pipes or other components during cold environments.

Variations of the invention are possible. For example, the invention may take the form of include an automated car wash system that includes a plurality of different interoperative module. The following provides a listing of exemplary modules of the invention and the component parts of the modules.

A supply module comprises at least one reservoir for storing water and at least one boiler for heating at least a portion of the stored water and for generating steam.

A delivery module may be coupled to the control module, the delivery module may comprise: at least one pump and at least one motor for transporting water at a pressure level and temperature level; at least one pump and at least one motor for transporting water into the boiler to generate steam; and at least one blower motor for transporting air at a pressure level.

An outputting module may be provided coupled to the delivery module. The outputting module may comprise: a valve assembly configured to receive water or steam from the delivery module, the valve assembly including at least one valve for controlling the flow of water to different outputs; one or more nozzle assemblies configured to dispense water or steam toward a vehicle, each nozzle assembly comprising a plurality of nozzles configured to output water or steam at a pressure level and temperature level; one or more nozzle assemblies configured to dispense air toward a vehicle, each nozzle assembly comprising a plurality of nozzles configured to output air at a pressure level; and a hose assembly configured to receive air from the delivery module.

A gantry module may be coupled to a motion module. The gantry module may comprise a plurality of support beams and connecting joints for holding the gantry module together and supporting the motion module.

A motion module may be coupled to the gantry module, the outputting module, and the control module. The motion module may comprise: a drive assembly configured to receive input from the control module, the drive assembly including a plurality of motors, gearboxes, and wheels for controlling the movement of the motion module; an articulating assembly configured to receive input from the control module, the articulating assembly including a plurality of joints, motors and gearboxes for controlling the movement of the outputting module; and a sensor assembly configured to give input to the control module, the sensor assembly including a plurality of sensors for monitoring the behavior of the motion module.

A communication module may be coupled to the control module. The communication module may comprise: at least one network server configured to allow communication with the control module and store the communicated data; a software program configured to operate on a smart device and communicate with the network server(s); a trigger assembly configured to be recognized by the software program, which in turn gives input to the network server(s); and a network assembly configured to provide a communication path between the control module and the communication module.

A vision module may be coupled to the control module. The vision module may comprise a plurality of sensors configured to identify an object and give input to the control module.

A safety module may be coupled to the control module. The safety module may comprise a plurality of sensors configured to monitor the operation of all modules of the automated car wash system and provide input to the control module.

A control module may be coupled to the delivery module, outputting module, motion module, communication module, vision module, and safety module. The control module may be configured to operate the automated car wash system. The control module may comprise: one or more processors coupled to memory containing code that when executed by the one or more processors causes the one or more processors to perform the automated cleaning of a vehicle using steam, water, and/or air; a 3D-vision software algorithm configured to construct a 3D model of the subject object based on the input captured by the plurality of sensors; a “wash path” software algorithm configured to calculate and generate the optimal “wash path” based on the output of the 3D-vision software algorithm; and a safety software algorithm configured to detect and prevent potentially damaging, harmful, or unexpected behavior of the automatic car wash system.

Materials used in the components of the invention may vary. For example, the reservoir may be made of metal or plastic or a combination of metal and plastic

The invention may include or exclude component parts as appropriate. For example, the delivery module may include at least one variable frequency drive (VFD) configured to output a signal at different frequencies to the motor(s) to define and adjust the pressure level of the water. At least one variable frequency drive may be configured to output a signal at different frequencies to the boiler(s) to define and adjust the temperature of the steam. The variable frequency drive(s) may be controlled by the control module.

When a VFD is provided, the VFD outputs signal at different frequencies to the motor(s) to define the speed which in turn defines the flow rate and/or pressure. In the case of water, this defines and adjusts the pressure level of outputted water. In the case of steam, this defines and adjusts the flow and pressure entering the boiler which in turn defines and adjusts the temperature of the outputted steam.

In addition, plumbing details represents another novel and nonobvious aspect of the invention. For example, the pump(s) and motor(s) for transporting water may be high pressure pump(s) and motor(s). In addition of in the alternative, the valve assembly, which may be used to adjust of individual nozzles or sets of nozzles turning on or off, may be coupled between the pump and the one or more nozzle assemblies. In addition, or in the alternative, the nozzle assembly may consist or consist essentially of one of or a combination of high-pressure zero-degree oscillating nozzles configured to dispense water at a pressure level and temperature level, steam nozzles configured to dispense steam at a temperature level, and air-knife nozzles configured to dispense air at a pressure level. In some instances, the valve assembly may be generally used to control flow to various parts of the system. All metal piping within utilities cabinet may be formed from stainless steel to prevent rusting, and thus issues of rust based clogs and degradation at the nozzles.

In some instances, the gantry module is comprised of metal trusses. The gantry module may serve a dual purpose as a support structure and a rail platform on which the motion module operates. The gantry module may be modular and can be adjusted in all three physical dimensions. The drive assembly may consist of three axes, each axis with its own set of motors, gearboxes, and wheels. A biased counterweight system may be used to automatically retract the drive assembly as a failsafe in the event of power loss or system malfunction. An articulating assembly may consist of two rotating axes, each axis with its own set of motors and gearboxes. A series of mounting points may be provided at the end of the articulating assembly opposite from its 2-axis rotating joint on which the outputting module is coupled.

The sensor assembly, e.g., within the safety module may comprise a variety of sensors. For example, cameras, ultrasonic sensors, infrared sensors, capacitive sensors, pressure transmitters, pressure transmitters and flow transmitters may be used.

Motors, e.g., electric powered motors, within the motion module may be servo motors. Servo motors may take the form of closed loop servo motors with encoders to keep track of the relative position of the motors.

A communication module may be provided and configured to give and receive input to a plurality of the automated car wash systems. Similarly, a trigger assembly may be provided in the form of a visual trigger for the software program as part of the communication module. The visual trigger may be a QR or quick response code.

Boilers of the invention may be a natural gas boiler or electric boiler. When a variable frequency drive is used, it may be electrically powered.

In some instances, the delivery module is enclosed in a utility cabinet. The boiler may be provided as part of the supply module is enclosed in a utility cabinet. The utility cabinet containing the boiler as part of the supply module may be the same utility cabinet that contains the delivery module. The reservoir(s) may also be provided as part of the supply module can be enclosed in a utility cabinet or exposed. The utility cabinet that may contain the reservoir(s) as part of the supply module may be the same utility cabinet that contains the delivery module. The delivery module may comprise at least one temperature transmitter, at least one pressure transmitter, and at least one flow transmitter.

The supply module may comprise at least one temperature transmitter and at least one capacitive sensor. At least one capacitive sensor may be placed within the reservoir, and at least one capacitive sensor may be placed between the reservoir and each of the pumps.

Operation of Exemplary Inventive Process

The following provides a description of an exemplary process of the invention as a process.

A car pulls in the inventive car wash and is physically constrained in operating volume width by guide rails. A sensor array (might be infrared or IR, ultrasonic, both) provides driver with feedback on lengthwise positioning.

User is prompted to stop car, ultrasonic/IR/3-dimensional (or 3D) scanning and app feedback initiate controller to begin wash sequence and run check on safety parameters. Scanners may use visual markers to recalibrate (may occur before or after wash sequence initiated). Tool-head moves into an extreme position to touch off on sensors (likely inductive) to check global positioning. All checks within safety module code base are green lit. Temperature/pressure/flow rate/amp draw/reservoir capacity/electrical connections are within specified operating range (each can be set individually and updated with the security clearance required to edit safety code).

Then, 3D images are taken from multiple stationary or motion-controlled angles to create an entire 3D point cloud of car surface to 0.1-2.5 cm accuracy. 3D images may or may not be augmented with additional sensor data to augment model (i.e. ultrasonic sensor(s) on window/window gaps, localized high resolution structured light sensor(s) to detect smaller items such as an antenna).

A toolpath may be generated to result in the creation of a numerical control file to trace specified vectors using a motion platform. Vectors include x, y, z, pitch and roll with the potential to add yaw in future iterations. These vectors will likely remain within 10% of orthogonal to the surface for washing. Operating zone for the toolpath exists between 3 to 6 inches for washing. Other operating zones may also be introduced for other processes that follow a predetermined toolpath (i.e. the operating zone for a drying path may include a shell from 6-9 in away from the car surface.

Computer vision is also utilized to determine common car features to aid in wash efficiency and quality. All path generations will attempt to identify wheel and windows which allows the vectors to be adjusted accordingly for said features. (i.e. speed may be reduced on wheels by 20-40% and increased on windows by 10-30%).

Up to 6 motors create 5 axes of motion. 2 motors operate belt and pulley system to create motion along the x-axis. 1 motor operates a belt and pulley system for the y-axis motion. 1 motor operates a belt and pulley system with pneumatic counterbalancing to create motion in the z-axis. Identical belt and pulley systems create the pitch/roll motion by rotary joints. Pitch has between 100 and 200 degrees of motion while roll has between 360 and 420 degrees of motion. Positional accuracy is maintained through closed loop, relative motion encoders on all six motors.

Optionally, joints of all linear axes are linear sliders with a high strength low friction plastic interface to facilitate effective motion. This interface also creates an intentional failure point that prevents drastic system damage if a car were to hit the z-axis column. Throughout all motion sequences ultrasonic sensors on the toolhead double check the positioning of the car to maintain assurance that the physical car and physical toolhead still align with the computer model of the car and toolhead.

Also optionally, the toolhead may consist essentially of modular racks on which columns of various nozzles may be attached. The toolhead can accommodate up to 6 columns of such nozzles as steam high pressure water and air. The system may exhibit a capability to adjust angles of individual sections of nozzles, e.g., zero degree oscillating nozzles for high pressure water to maximize the ratio of impact force to water consumption, and/or flat fan steam nozzles to maximize steam velocity. An air knife for drying may be provided as well.

As a general rule, safety concerns may be addressed using a variety of sensors (ultrasonic, IR, rotary encoder, possibly LIDAR, possibly sonar, other 3D/vision/camera sensors). Such sensors are used to constantly communicate with the main controller to ensure the safe operation of the system. Safe operation includes prevention of damage to a vehicle or living things, detection of intruders or anomalies, detecting component failure or unexpected operation, extreme environmental conditions, vehicles unfit for automated cleaning due to pre-existing damage or excessive aging/wear, etc.

In addition, utilities may be managed within the utility cabinet and divided into two lines from a central reservoir. The reservoir is of a size to run a minimum of one full wash without taking in any additional water.

Furthermore, VFDs may operate direct drive pump motors. The VFDs are controlled by the central controller. Each VFD is able to monitor amp draw of each motor and report values back to central controller for analysis. The pumps being driven by said motors provide water to the boiler for steam generation as well producing the high-pressure water that is pumped through a high pressure water hose directly to the zero-degree oscillating steam nozzles on the toolhead.

Further still, boilers such as industrial steam generators may be used to convert input water and transforms it into a pure steam output. All steam hoses may have double containment to prevent any damage that may be caused from an unexpected leak or rupture.

In any case, both the steam output hose and the high-pressure water output hose may run a distance equal to or greater than the length required to reach each extreme position as determined by the constraints of motion platform geometry. Routing along a linear axis may consist of a drag chain cable/hose routing mechanism. All cables/hoses may pass through the center of rotation of rotary joints and thus eliminate the need for translational routing mechanisms.

Although the invention has been described with respect to specific embodiments, it will be appreciated that the invention is intended to cover all modifications and equivalents within the scope of the following claims.

What is claimed is:

1. An automated car wash system, comprising:
a supply module comprising a reservoir or other supply of water and a boiler for transforming at least a portion of water into steam;
a delivery module coupled to the control module, the delivery module comprising a motor and a pump for transporting the steam at a pressure level;
an outputting module coupled to the delivery module, the outputting module comprising:
a valve assembly configured to receive steam from the delivery module, the valve assembly including a plurality of valves for controlling the flow of steam to different outputs; and
one or more nozzle assemblies configured to dispense steam toward a vehicle, each nozzle assembly comprising a plurality of nozzles configured to output pressurized steam; and
a control module coupled to the delivery module and outputting module and configured to operate the automated car wash system, the control module comprising one or more processors coupled to memory containing code that when executed by the one or more processors causes the one or more processors to perform automated steam cleaning of a vehicle.

2. The automated car wash system of claim 1, wherein the boiler is configured to generate a fluid that has a temperature of at least 100° C.

3. The automated car wash system of claim 1, wherein the one or more nozzle assemblies are movable by respective one or more motors to position the one or more nozzle assemblies at a position suitable for steam cleaning.

4. An automated car wash system, comprising:
a supply module comprising at least one reservoir for storing water and at least one boiler for heating at least a portion of the stored water and for generating steam;
a delivery module coupled to the control module, the delivery module comprising at least one pump and at least one motor for transporting water at a pressure level and temperature level, at least one pump and at least one motor for transporting water into the boiler to generate steam, and at least one blower motor for transporting air at a predetermined pressure level;
a fluid outputting module coupled to the delivery module;
an optional gantry module;
a motion module coupled to the gantry module, the outputting module, and the control module;
a network-server based communication module coupled to a control module;
a vision module coupled to the control module, the vision module comprising a plurality of sensors configured to identify an object and give input to the control module, a safety module coupled to the control module, the safety module comprising a plurality of sensors configured to monitor the operation of all modules of the automated car wash system and provide input to the control module; and
a control module, coupled to the delivery module, outputting module, motion module, communication module, vision module, and safety module, configured to operate the automated car wash system, the control module comprising:
one or more processors coupled to memory containing code that when executed by the one or more processors causes the one or more processors to perform the automated cleaning of a vehicle using steam, water, and/or air;
a 3D-vision software algorithm configured to construct a 3D model of the subject object based on the input captured by the plurality of sensors;
a wash path software algorithm configured to calculate and generate the optimal wash path based on the output of the 3D-vision software algorithm;
a safety software algorithm configured to detect and prevent potentially damaging, harmful, or unexpected behavior of the automatic car wash system.

5. The automated car wash system of claim 4, wherein the delivery module includes
at least one variable frequency drive configured to output a signal at different frequencies to the motor to define the speed of the motor which affects the flow rate of fluid into the pump which combined with the nozzles affects the pressure of water outputted; and
at least one variable frequency drive configured to output a signal at different frequencies to the motor to define the speed of the motor which affects the flow rate of fluid into the pump which adjusts the temperature of steam or hot water produced.

6. The automated car wash system of claim 4, wherein the drive assembly consists of three axes, each axis with its own set of motors, gearboxes, and wheels.

7. The automated car wash system of claim 6, further comprising a biased counterweight system to automatically retract the drive assembly as a failsafe in the event of power loss or system malfunction.

8. The automated car wash system of claim 4, wherein the articulating assembly consists of two rotating axes, each axis with its own set of motors and gearboxes.

9. The automated car wash system of claim 8, further comprising a series of mounting points at the end of the articulating assembly opposite from its 2-axis rotating joint on which the outputting module is coupled.

10. The automated car wash system of claim 4, wherein the motors within the motion module are servo motors.

11. The automated car wash system of claim 10, wherein the servo motors are closed loop servo motors with encoders to keep track of the relative position of the motors.

12. The automated car wash system of claim 4, wherein the communication module is configured to give and receive input to a plurality of automated car wash systems.

13. The automated car wash system of claim 4, wherein a trigger assembly is provided that is a visual trigger for the software program as part of the communication module.

14. The automated car wash system of claim 13, wherein the visual trigger is a QR code.

15. The automated car wash system of claim 4, wherein the boiler as part of the supply module is enclosed in a utility cabinet.

16. The automated car wash system of claim 15, wherein the utility cabinet containing the boiler as part of the supply module may be the same utility cabinet that contains the delivery module.

17. The automated car wash system of claim 4, wherein the reservoir as part of the supply module can be enclosed in a utility cabinet or exposed.

18. The automated car wash system of claim 4, wherein the delivery module comprises at least one temperature transmitter, at least one pressure transmitter, and at least one flow transmitter.

19. The automated car wash system of claim 4, wherein the supply module comprises at least one temperature transmitter and at least one capacitive sensor.

20. An automated car wash system, comprising:
a supply module comprising at least one reservoir for storing water and at least one boiler for heating at least a portion of the stored water and for generating steam;
a delivery module coupled to a control module;
an outputting module coupled to the delivery module;
an optional gantry module includes 3D-vision software algorithm and a wash path algorithm;
a motion module coupled to the gantry module, the outputting module, and the control module;
a communication module coupled to the control module;
a vision module coupled to the control module; and
a safety module coupled to the control module.
